(19) United States
(12) Patent Application Publication
(10) Pub. No.: US 2011/0217605 A1
(43) Pub. Date: Sep. 8, 2011

(54) FUEL CELL, OXYGEN ELECTRODE USED IN FUEL CELL, AND ELECTRONIC DEVICE

(75) Inventor: Kengo Makita, Kanagawa (JP)

(73) Assignee: SONY CORPORATION, Tokyo (JP)

(21) Appl. No.: 13/126,705

(22) PCT Filed: Nov. 4, 2009
(86) PCT No.: PCT/JP2009/068810

§ 371 Date: Apr. 28, 2011

(30) Foreign Application Priority Data
Nov. 7, 2008 (JP) 2008-286420

(51) Int. Cl. H01M 8/06

(52) U.S. Cl. 429/414

(57) ABSTRACT

Provided are a fuel cell capable of improving power generating characteristics, and an electronic device using the same. The fuel cell includes a fuel/electrolyte flow path between an oxygen electrode and a fuel electrode. An external member is bonded onto a surface of a current collector constituting the oxygen electrode with an adhesive film in between. A grooving process is performed on the adhesive film, and an air flow path is provided between the current collector and the external member. Air (oxygen) is supplied to the oxygen electrode through the air flow path. A water repellent region is provided on the surface of the current collector corresponding to the air flow path. By using the adhesive film, strong adhesiveness is obtained between the air flow path and the current collector, so water discharging capability is improved while the adhesiveness is maintained.

### CROSS REFERENCE TO RELATED APPLICATIONS

The present application is a National Stage of International Application No. PCT/JP2009/068810 filed on Nov. 4, 2009, which claims priority to Japanese Patent Application No. 2008-286420 filed on Nov. 7, 2008, the entire contents of which are being incorporated herein by reference.

### BACKGROUND

In recent years, there is a tendency in a mobile device that power consumption is increased with high performance, and a fuel cell has been regarded as promising as a battery in substitution for a lithium ion secondary battery. Depending on used electrolytes, the fuel cells are classified into alkaline fuel cells (AFC), phosphoric acid fuel cells (PAFC), molten carbonate fuel cells (MCFC), solid electrolyte fuel cells (SOFC), polymer electrolyte fuel cells (PEFC), and the like.

Various combustible substances such as hydrogen and methanol can be used as fuels for the fuel cell. However, because a storage cylinder or the like is necessary for gas fuels such as the hydrogen, the gas fuels are not suitable for size reduction. Meanwhile, liquid fuels such as the methanol have an advantage that they are easily stored. Especially, in the DMFC, because a reformer for extracting the hydrogen from the fuels is not necessary, and the structure is thus simplified, there is an advantage that the size reduction is easy.

The energy density of the methanol as the fuel of the DMFC is theoretically 4.8 kW/L, and it is ten times or more of the energy density of a typical lithium ion secondary battery. That is, the fuel cell using the methanol as the fuel has a great potential to exceed the lithium ion secondary battery in the energy density. From these, the DMFC has the highest possibility to be used as the energy source for mobile devices, electrical vehicles, and the like among various fuel cells.

However, there is a common issue in the DMFC using a liquid electrolyte, and a solid electrolyte. First, a phenomenon in which hydrogen ions (protons) generated by reaction in the fuel cell travel together with water to an oxygen electrode in a film or an electrolytic solution, that is, electro-osmosis is generated. Further, because the water is generated in the reaction in the oxygen electrode, the water is excessive, and flooding occurs on the oxygen electrode side. Thus, supply of an oxygen gas is inhibited, and there is an issue that the power generating characteristics are notably deteriorated.

To suppress the flooding, a porous carbon material is typically used as a gas diffusing base material on the oxygen electrode side. To increase the water repellency of that material, the material is dipped in a dispersion of PTFE (polytetrafluoroethylene), drawn up, dried, and sintered to fabricate a complex of the PTFE and the carbon material, and a catalyst is carried onto the surface of the complex. Further, there are many cases that a separator material to be brought into a direct contact with this diffusing base material is formed from the carbon material, and the water repellent treatment may be performed onto an inner surface of an oxygen gas conduction groove formed in the separator to increase the water repellency.

However, the level of the water repellency, the structure of the water repellency, and the like desired in the water management of the fuel cell using the liquid electrolyte and the solid electrolyte are influenced by operation conditions or the like of the fuel cell, so an optimal gas diffusing base material, and an optimal water repellent structure depend on the fuel cell itself.

Thus, there has been proposed a fuel cell having a structure in which the oxygen gas conduction groove through which the oxygen gas flows is formed, the oxygen gas conduction groove is gradually deepened from a gas inlet to a gas outlet, and the generated excessive water such as condensed water is discharged by utilizing a tilt of the oxygen gas conduction groove (for example, Patent Document 1).

### Citation List

### Patent Documents

Patent Document 1: Japanese Unexamined Patent Publication No. Sho 62-204442

Patent Document 2: Japanese Patent No. 3066088

Patent Document 3: Examined Patent publication No. Sho 54-7458

Patent Document 4: Japanese Unexamined Patent Publication No. 2006-281751

Patent Document 5: Japanese Unexamined Patent Publication No. 2003-72244

Patent Document 6: Japanese Unexamined Patent Publication No. 2003-182237

Patent Document 7: Japanese Unexamined Patent Publication No. 2005-125726

Patent Document 8: Japanese Unexamined Patent Publication No. 2005-129192

### SUMMARY

The present disclosure relates to a fuel cell such as a direct methanol fuel cell (DMFC; Direct Methanol Fuel Cell) in which methanol is directly supplied to a fuel electrode to react, an oxygen electrode used in the same, and an electronic device including the fuel cell.

However, it is not said that the capability to discharge the excessive water such as the condensed water is sufficient in the method in which the generated water is discharged by the tilt of the oxygen gas conduction groove. As a result, it is not possible to sufficiently improve the flooding state, and the supply of the oxygen gas to the oxygen electrode is inhibited. Thus, there is an issue that the power generating characteristics are deteriorated.

In view of the foregoing problems, it is a first object of the present disclosure to provide a fuel cell capable of improving power generating characteristics, and an electronic device using the same.

It is a second object of the present disclosure to provide an oxygen electrode suitable for the fuel cell.

A fuel cell according to an example embodiment of the present disclosure includes an oxygen electrode, a fuel electrode, and an air-flow-path formation member. The oxide electrode includes a first face and a second face facing each other, and a current collector is disposed on the first face side. The air-flow-path formation member forms an air flow path in corporation with the current collector. On a surface of the current collector, a water repellent region is provided corresponding to at least part of the air flow path. The fuel electrode is disposed on the second face side of the oxygen electrode.

An oxide electrode according an example embodiment of the present disclosure has a structure including a current collector disposed on a catalyst layer with a diffusing layer in between. On a surface of the current collector, an air-flow-path formation member is provided, and an air flow path is formed. On a surface of the current collector, a water repellent region is included in a position corresponding to at least part of the air flow path.

An electronic device according to an example embodiment of the present disclosure includes the above-described fuel cell.

In the fuel cell and the electronic device according to the example embodiments of the present disclosure, the water generated in the oxygen electrode is water-repellent by the water repellent region provided on the current collector, and is efficiently discharged.

According to the fuel cell and the electronic device according to the example embodiments of the present disclosure, because the water repellent region is provided on the current collector of the oxygen electrode, it is possible to improve the capability to discharge the water generated in the oxygen electrode. Also, because the water repellent region is not provided in a region other than the air flow path on the current collector, it is possible to further improve the water discharging capability while an air leakage is prevented, compared with the case where the water repellent region (water repellent layer) is provided on the whole surface of the current collector. Therefore, it is possible to suppress flooding in the oxygen electrode, and improve power generating characteristics.

Additional features and advantages are described herein, and will be apparent from the following Detailed Description and the figures.

### BRIEF DESCRIPTION OF THE FIGURES

FIG. 1 is a cross-sectional view illustrating the structure of a fuel cell according to an example embodiment of the present disclosure.

FIG. 2 is an exploded perspective view illustrating a current collector and a water repellent region constituting an oxygen electrode of the fuel cell illustrated in FIG. 1.

FIG. 3 is a view illustrating the schematic structure of a fuel cell system including the fuel cell illustrated in FIG. 1.

FIG. 4 is a characteristic view of the fuel cell provided with the water repellent region.

FIG. 5 illustrates long-period characteristics of the fuel cell depending on presence or absence of the water repellent region.

### DETAILED DESCRIPTION

Hereinafter, an example embodiment of the present disclosure will be described in detail with reference to drawings.

Structure Example of Fuel Cell

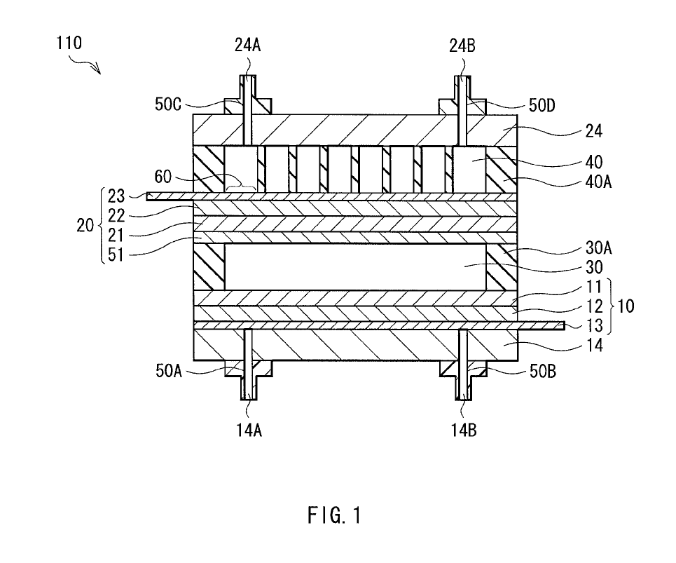

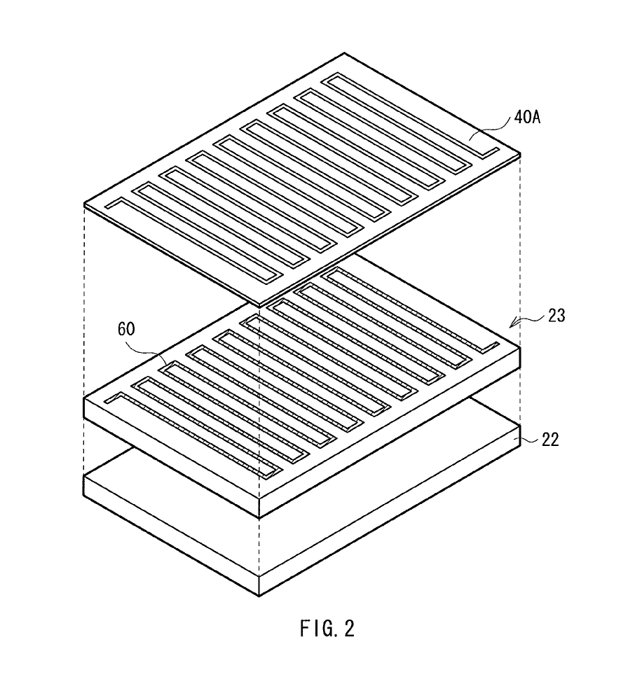

FIG. 1 illustrates the cross-sectional structure of a fuel cell 110 according to an example embodiment of the present disclosure. The fuel cell 110 is a so-called direct methanol flow based fuel cell (DMFFC), and has the structure in which a fuel electrode 10 and an oxygen electrode 20 are oppositely arranged. FIG. 2 perspectively explodes a diffusing layer 22, a current collector 23, an adhesive film 40A, and a water repellent region 60 of FIG. 1.

An air flow path 40 supplying air, that is, oxygen is provided on the surface (first face) of the oxygen electrode 20. Meanwhile, on the rear surface (second face) side of the oxygen electrode 20, a fuel/electrolyte flow path 30 through which a mixed solution of a fuel and an electrolyte flows is provided between the oxygen electrode 20 and the fuel electrode 10. External members 14 and 24 are provided on the outer sides of the fuel electrode 10, and the oxygen electrode 20, respectively.

In the fuel electrode 10, a diffusing layer 12 and a catalyst layer 11 are stacked in this order on a current collector 13. Likewise, the oxygen electrode 20 has the structure in which the diffusing layer 22 and a catalyst layer 21 are stacked in this order on the current collector 23. The catalyst layer 11 and the catalyst layer 21 face the fuel/electrolyte flow path 30.

A functional layer 51 provided in the oxygen electrode 20 has a function of preventing an overvoltage generated in the oxygen electrode 20 due to a fuel crossover (an overvoltage suppressing layer), while holding an ion path between a fuel/electrolytic solution and the catalyst layer 21. Moreover, the functional layer 51 suppresses the flooding of the oxygen electrode 20 (a flooding suppressing layer), and is a deterioration preventing layer suppressing deterioration such as cracks and holes of the oxygen electrode 20 generated due to a direct contact between the catalyst layer 21 and the electrolytic solution. By providing the functional layer 51, it is possible to moderate or invalidate the fuel crossover and the flooding state of the oxygen electrode 20.

The functional layer 51 is, for example, constituted of a porous material. By fine pores in the porous material, it is possible to ensure the ion path between the electrolytic solution containing the fuel, and the catalyst layer 21. Specific examples of the porous material include metal, carbon, a resin such as polyimide, or ceramic, or a blend layer formed of a plurality of these materials may be used. Whether the resin has the water repellency or the hydrophilicity is not in question. The thickness of the functional layer 51 is, for example, approximately 1μm to 100 μm, but it is desirably as thin as possible.

The fine pores of the functional layer 51 preferably have, for example, the diameter of a nanometer order to a micrometer order, but the diameter is not specifically limited.

Moreover, the functional layer 51 may be constituted of an ion conductor such as a proton conductor. Examples of the proton conductor include a polyperfluoroalkyl sulfonic acid resin (“Nafion (registered trademark)” manufactured by E. I. du Pont de Nemours and Company), a polystyrene sulfonic acid, a fullerene-based conductor, a solid acid, or a resin having the other proton conductivity.

The diffusing layers 12 and 22 are, for example, constituted of carbon cloth, carbon paper, or a carbon sheet. The diffusing layers 12 and 22 are desirably provided with the water repellent treatment by polytetrafluoroethylene (PTFE), or the like. However, the diffusing layers 12 and 22 are not necessarily provided, and catalyst layers 11 and 21 may be formed directly on the current collectors 13 and 23.

As the catalyst, the catalyst layers 11 and 21 contain, for example, a metal as a simple substance such as palladium (Pd), platinum (Pt), iridium (Ir), rhodium (Rh), and ruthenium (Ru), an alloy of these, an organic complex, oxygen or the like.

In addition to the above-described catalysts, a proton conductor, and a binder may be contained in the catalyst layers 11 and 21. Examples of the proton conductor include the above-described polyperfluoroalkyl sulfonic acid resin (“Nafion (registered trademark)” manufactured by E. I. du Pont de Nemours and Company), or a resin having the other proton conductivity. The binder is added to hold the strength and the flexibility of the catalyst layers 11 and 21, and examples of the binder include a resin such as polytetrafluoroethylene (PTFE) and polyvinylidene fluoride (PVDF).

The current collector 13 is, for example, constituted of a porous material or a plate member having the electrical conductivity, specifically, a titanium (Ti) mesh, a titanium plate, or the like.

The current collector 23 is, for example, constituted of the porous material in which a punching process is performed on the titanium mesh, the titanium plate, or the like. This is because the air (oxygen) is necessary for the reaction generated in the oxygen electrode 20, and the air has to pass through the oxygen electrode 20. Therefore, the current collector 23, the diffusing layer 22, and the catalyst layer 21 constituting the oxygen electrode 20 are preferably porous material. In addition, the material of the current collector 23 is not limited to the titanium, and other metals may be used.

On the air flow path 40 side of the current collector 23, the water repellent treatment is performed on a flow path portion through which the air flows, and the water repellent treatment is not performed on a portion through which the air does not flow (a contact portion of the resin film flow path and the current collector=a rib or the like). That is, the water repellent region 60 is formed along the air flow path 40 on the surface of the current collector 23. The water repellent region 60 is preferably formed in the whole region corresponding to the air flow path 40, but may be selectively formed.

Each of the external members 14 and 24 is, for example, 1 mm in thickness, and is constituted of a material typically available such as a metal plate including a titanium (Ti) plate and the like, and a resin plate, but the material is not specifically limited. In addition, the thickness of the external members 14 and 24 is desirably as thin as possible. Moreover, the external materials may be used for the current collectors 13 and 23.

In the fuel/electrolyte flow path 30, for example, a fine flow path is formed by processing a resin sheet 30A, and the fuel/electrolyte flow path 30 is bonded onto one side of the fuel electrode 10 facing the oxygen electrode 20. A fluid containing the fuel and the electrolyte, for example, a mixed solution of the methanol and the sulfuric acid is supplied from a fuel/electrolyte inlet 14A and a fuel/electrolyte outlet 14B provided in the external member 14 to the fuel/electrolyte flow path 30 through a through-hole 50A and a through-hole 50B. In addition, the number and the shape of the flow path are not limited, and the shape of the flow path may be, for example, a snake-shape, or a parallel. Further, the width, the height, and the length of the flow path are not specifically limited, but are desirably as small as possible. The fuel and the electrolyte in the mixed state may pass through inside the fuel/electrolyte flow path 30, or the fuel and the electrolytic solution which are separated in layers may pass through inside the fuel/electrolyte flow path 30.

The air flow path 40 is, for example, formed of the adhesive film 40A (an air-flow-path formation member). In this example embodiment, strong adhesiveness onto the current collector 23 is obtained by using the adhesive film 40A. The air is supplied from an air inlet 24A and an air outlet 24B provided in the external member 24 to the air flow path 40 through a through-hole 50C and a through-hole 50D by natural ventilation, or a forcible supplying method using a fan, a pump, a blower or the like. Like the fuel/electrolyte flow path 30, the air flow path 40 is not limited in structure.

The above-described fuel cell 110 can be manufactured, for example, as will be described next.

Example of Manufacturing Method of Fuel Cell

First, as the catalyst, for example, an alloy containing the platinum (Pt) and he ruthenium (Ru) at a predetermined ratio, and a dispersion solution of the polyperfluoroalkyl sulfonic acid resin (“Nafion (registered trademark)” manufactured by E. I. du Pont de Nemours and Company) are mixed at a predetermined ratio, and the catalyst layer 11 of the fuel electrode 10 is thus formed. This catalyst layer 11 is bonded by thermal compression onto the diffusion layer 12 made of the above-described material. Next, the diffusing layer 12 and the catalyst layer 11 are bonded by thermal compression onto one surface of the current collector 13 made of the above-described material by using a hot-melt adhesive, or an adhesive resin sheet, and the fuel electrode 10 is thus formed. In addition, the catalyst layer 11 may be directly formed on the current collector 13, without formation of the diffusing layer 12 as described above.

Further, as the catalyst, the platinum (Pt) carried by the carbon, and the dispersion solution of the polyperfluoroalkyl sulfonic acid resin (“Nafion (registered trademark)” manufactured by E. I. du Pont de Nemours and Company) are mixed at a predetermined ratio, and the catalyst layer 21 of the oxygen electrode 20 is thus formed. This catalyst layer 21 is bonded by thermal compression onto the diffusing layer 22 made of the above-described material. Next, the functional layer 51 made of the above-described material is formed on the face of the catalyst layer 21 on which the diffusing layer 22 is not formed. Further, the current collector 23 made of the above-described material is bonded by thermal compression onto the diffusing layer 22, and the water repellent region 60 is formed in a flow path shape through which the air passes, on the current collector 23 on the opposite side to the diffusing layer 22. Meanwhile, after the adhesive film 40A is prepared, and the air flow path 40 is formed in the adhesive film 40A, the air flow path 40 is bonded by thermal compression onto the face of the current collector 23 on which the water repellent region 60 is formed.

Next, the adhesive resin sheet 30A is prepared, a flow path is formed in the resin sheet to form the fuel/electrolyte flow path 30, and the fuel/electrolyte flow path 30 is bonded by thermal compression onto a face of the fuel electrode 10 facing the oxygen electrode 20.

Next, the external members 14 and 24 made of the above-described material are fabricated. The external member 14 is, for example, provided with the fuel/electrolyte inlet 14A and the fuel/electrolyte outlet 14B made of resin joints, and the through-holes 50A and 50B, and the external member 24 is, for example, provided with the air inlet 24A and the air outlet 24B made of the resin joints, and the through-holes 50C and 50D.

After that, the oxygen electrode 20 is bonded onto the fuel/electrolyte flow path 30 on which the thermal compression bonding is performed, and accommodated in the external members 14 and 24. Thereby, the fuel cell 110 illustrated in FIGS. 1 and 2 is completed.

Next, operations and effects of the above-described fuel cell 110 will be described.

When the fuel and the electrolyte are supplied to the fuel electrode 10 by the fuel/electrode flow path 30 in the fuel cell 110, protons and electrons are generated by the reaction. The protons travel to the oxygen electrode 20 through the fuel/electrolyte flow path 30, and reacts with the electrons and the oxygen to generate the water. The reactions generated in the fuel electrode 10, the oxygen electrode 20, and the whole fuel cell 110 are represented by the formulas 1 to 3. Thereby, part of chemical energy of the methanol as being the fuel is converted into electrical energy, and extracted as electrical power. In addition, carbon dioxide generated in the fuel electrode 10, and the water generated in the oxygen electrode 20 flow out to the fuel/electrolyte flow path 30, and are extracted.

Fuel electrode 10: CH₃OH+H₂O→CO₂+6e⁻+6H (1)

Oxygen electrode 20: (3/2)O₂+6e⁻6H⁺→3H₂O (2)

Whole fuel cell 110: CH₃OH+(3/2)O₂→CO₂+2H₂O (3)

In this example embodiment, because the water repellent region 60 on which the water repellent treatment along the air flow path 40 is performed is provided on the face of the current collector 23 on which the air flows, the water passing through the air flow path 40 is discharged without flowing backward to the fuel/electrolyte flow path 30. Also, the water passing through the air flow path 40 is in a bead shape due to the water repellent treatment, so it is efficiently discharged outside from the fuel cell 110.

Further, the water repellent treatment is performed only on part of the current collector 23 along the air flow path 40, so the air flow path 40 formed by using the adhesive film 40A is strongly bonded onto the current collector 23. Accordingly, the air flow is uniformized, the air flow path 40 with no air leakage is formed, and the capability to discharge the water generated on the oxygen side is further improved.

As described above, in this example embodiment, because the water repellent region 60 is formed along the air flow path 40 on the current collector 23 facing the air flow path 40 side, it is possible to improve the capability to discharge the water generated in the oxygen electrode 20. Further, because the water repellent treatment is performed only on part of the current collector 23 along the air flow path 40, the adhesiveness of the current collector 23 and the air flow path 40 is maintained, and the capability to discharge the water generated on the oxygen electrode side is drastically improved. Therefore, it is possible to suppress the flooding in the oxygen electrode 20, and improve the power generating characteristics.

Application Example

Next, an application example of the above-described fuel cell 110 will be described.

Structure Example of Fuel Cell System

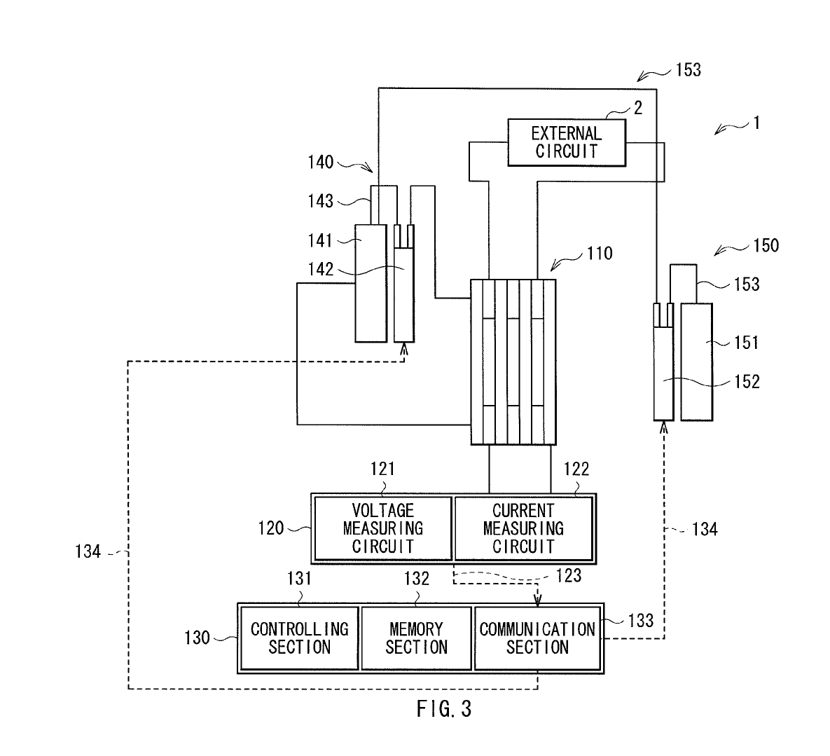

FIG. 3 illustrates the schematic structure of an electronic device having the fuel cell system including the fuel cell 110 of the present disclosure. The electronic device is, for example, a mobile device such as a mobile phone and a PDA (Personal Digital Assistant), or a notebook PC (Personal Computer), and includes a fuel cell system 1, and an external circuit (load) 2 driven by electrical energy generated by the fuel cell system 1.

The fuel cell system 1 includes, for example, the fuel cell 110, a measuring section 120 measuring the drive conditions of the fuel cell 110, and a controlling section 130 determining the drive conditions of the fuel cell 110 based on measurement results by the measuring section 120. Moreover, the fuel cell system 1 includes a fuel/electrolyte supplying section 140 supplying a fluid containing the fuel and the electrolyte to the fuel cell 110, and a fuel supplying section 150 supplying, for example, only the fuel such as the methanol to a fuel/electrolyte storing section 141. In addition, the fuel/electrolyte flow path 30 in the fuel cell 110 is connected to the fuel/electrolyte supplying section 140 through the fuel/electrolyte inlet 14A and the fuel/electrolyte outlet 14B provided in the external member 14, and the fluid is supplied to the fuel/electrolyte flow path 30 from the fuel/electrolyte supplying section 140.

The measuring section 120 measures an operation voltage and an operation current of the fuel cell 110, and includes, for example, a voltage measuring circuit 121 measuring the operation voltage of the fuel cell 110, a current measuring circuit 122 measuring the operation current, and a communication line 123 transmitting the obtained measurement results to the controlling section 130.

The controlling section 130 controls a fuel/electrolyte supply parameter and a fuel supply parameter as the drive conditions of the fuel cell 110 based on the measurement results of the measuring section 120, and includes, for example, a calculating section 131, a memory section 132, a communication section 133, and a communication line 134. Here, the fuel/electrolyte supply parameter includes, for example, the supply flow rate of the fluid containing the fuel/electrolyte. The fuel supply parameter includes, for example, the supply flow rate and the supply amount of the fuel, and may include the supply concentration, if necessary. The controlling section 130 may be constituted of, for example, a microcomputer.

The calculating section 131 calculates the output of the fuel cell 110 from the measurement results obtained in the measuring section 120, and sets the fuel/electrolyte supply parameter and the fuel supply parameter. Specifically, the calculating section 131 averages anode potentials, cathode potentials, output voltages, and output currents sampled at regular intervals from various measurement results input to the memory section 132 to calculate an average anode potential, an average cathode potential, an average output voltage, and an average output current, input the calculated results to the memory section 132, and relatively compares the various averages stored in the memory section 132 to determine the fuel/electrolyte supply parameter and the fuel supply parameter.

The memory section 132 stores the various measurement values transmitted from the measuring section 120, the various averages calculated by the calculating section 131, and the like.

The communication section 133 has a function to receive the measurement results from the measuring section 120 through the communication line 123, and input the measurement results to the memory section 132, and a function to output signals for setting the fuel/electrolyte supply parameter to the fuel/electrolyte supplying section 140, and signals for setting the fuel supply parameter to the fuel supplying section 150, through the communication line 123, respectively.

The fuel/electrolyte supplying section 140 includes the fuel/electrolyte storing section 141, a fuel/electrolyte supply adjusting section 142, and a fuel/electrolyte supply line 143. The fuel/electrolyte storing section 141 stores the fluid, and is constituted of, for example, a tank or a cartridge. The fuel/electrolyte supply adjusting section 142 adjusts the supply flow rate of the fluid. Although the fuel/electrolyte supply adjusting section 142 is not specifically limited as long as it may be driven by signals from the controlling section 130, the fuel/electrolyte supply adjusting section 142 is preferably constituted of, for example, a bulb driven by a motor or a piezoelectric element, or an electromagnetic pump.

The fuel supplying section 150 includes a fuel storing section 151, a fuel supply adjusting section 152, and a fuel supply line 153. The fuel storing section 151 stores only the fuel such as the methanol, and is constituted of, for example, a tank or a cartridge. The fuel supply adjusting section 152 adjusts the supply flow rate and the supply amount of the fuel. Although the fuel supply adjusting section 152 is not specifically limited as long as it may be driven by signals from the controlling section 130, the fuel supply adjusting section 152 is preferably constituted of, for example, a bulb driven by a motor or a piezoelectric element, or an electromagnetic pump. In addition, the fuel supplying section 150 may include a concentration adjusting section (not illustrated in the figure) adjusting the supply concentration of the fuel. The concentration adjusting section may be omitted in the case where pure (99.9%) methanol is used as the fuel, and further size reduction is possible.

Moreover, the above-described fuel cell system 1 can be manufactured as will be described next.

Example of Manufacturing Method of Fuel Cell System

For example, the above-described fuel cell 110 is installed in a system including the measuring section 120, the controlling section 130, the fuel/electrolyte supplying section 140, and the fuel supplying section 150 which have the above-described structures, the fuel/electrolyte inlet 14A and the fuel/electrolyte outlet 14B, and the fuel supplying section 150 are, for example, connected with the fuel supply line 153 made of a silicone tube, and the fuel/electrode inlet 14A and the fuel/electrode outlet 14B, and the fuel/electrode supplying section 140 are, for example, connected with the fuel/electrode supply line 143 made of the silicone tube. Thereby, the fuel cell system 1 illustrated in FIG. 3 is completed.

In such a fuel cell system 1, when the fluid containing the fuel and the electrolyte is supplied from the fuel/electrolyte supplying section 140 to the fuel cell 110, the electric power is extracted from the fuel cell 110, and the external circuit 2 is driven. The operation voltage and the operation current of the fuel cell 110 are measured by the measuring section 120 during the operation of the fuel cell 110, and the above-described fuel/electrolyte supply parameter and the above-described fuel supply parameter as the operation conditions of the fuel cell 110 are controlled by the controlling section 130 based on the measurement results. The measurement by the measuring section 120 and the parameter control by the controlling section 130 are frequently repeated, and the supply state of the fluid and the fuel is optimized in accordance with the characteristic-variation of the fuel cell 110.

### EXAMPLE

Next, an example exhibiting effects of the above-described fuel cell 110, and the fuel cell system 1 including the fuel cell 110 will be described.

In the same manner as the above-described example embodiment, the fuel cell 110 illustrated in FIG. 1 was manufactured. First, as the catalyst, the alloy containing the platinum (Pt) and the ruthenium (Ru) at the predetermined ratio, and the dispersion solution of the polyperfluoroalkyl sulfonic acid resin (“Nafion (registered trademark)” manufactured by E. I. du Pont de Nemours and Company) were mixed at the predetermined ratio, and the catalyst layer 11 of the fuel electrode 10 was thus formed. The catalyst layer 11 was bonded by thermal compression onto the diffusion layer 12 (manufactured by E-TEK Electronics Manufactory Ltd.; HT-2500) made of the above-described material for 10 minutes under the conditions that the temperature was 150° C. and the pressure was 249 kPa. Further, the current collector 13 made of the above-described material was bonded by thermal compression with the hot-melt adhesive, or the adhesive resin sheet, and the fuel electrode 10 was thus formed

Moreover, as the catalyst, the platinum (Pt) carried by the carbon, and the dispersion solution of the polyperfluoroalkyl sulfonic acid resin (“Nafion (registered trademark)” manufactured by E. I. du Pont de Nemours and Company) were mixed at the predetermined ratio, and the catalyst layer 21 of the oxygen electrode 20 was thus formed. The catalyst layer 21 was bonded by thermal compression onto the diffusing layer 22 (manufactured by E-TEK Electronics Manufactory Ltd.; HT-2500) made of the above-described material in the same manner as the catalyst layer 11 of the fuel electrode 10. Further, the current collector 23 made of the above-described material was bonded by thermal compression in the same manner as the current collector 13 of the fuel electrode 10, and the oxygen electrode 20 was thus formed.

A titanium mesh (SW=0.5, LW=1.0) with a thickness of 200 μm was used as the current collector 23, and the water repellent region 60 was formed on one face of the titanium mesh before the oxygen electrode 20 was fabricated. That is, a PTFE dispersion solution (Asahi Glass Co., Ltd, AD938L) was sprayed in an arbitrary patterning to the face of the titanium mesh, which is in contact with the air. After that, it was dried at a room temperature, and burned for two hours under the conditions at 370° C. Thereby, the water repellent region 60 was formed on the one face of the titanium mesh, which is in contact with the air.

An adhesive resin film processed in an arbitrary shape (shape corresponding to the water repellent region 60) was bonded onto the face of the oxygen electrode 20, which is in contact with the air, and the air flow path 40 was thus formed. Pylarux (manufactured by E. I. du Pont de Nemours and Company) was used as the adhesive resin film, and the thermal compression bonding was performed for 3 minutes at 150° C. and 0.25 kN.

Next, the adhesive resin sheet was prepared, and the flow path was formed in the resin sheet to bond the fuel/electrolyte flow path onto between the fuel electrode 10 and the air electrode 20 by thermal compression.

Next, the external members 14 and 24 made of the above-described material were fabricated, and the air inlet 24A and the air outlet 24B made of, for example, the resin joints were provided in the external member 24. The fuel/electrolyte inlet 14A and the fuel/electrolyte outlet 14B made of for example, the resin joints were provided in the external member 14. Next, the fuel/electrode flow path 30 was arranged between the fuel electrode 10 and the oxygen electrode 20, and the fuel electrode 10 and the oxygen electrode 20 were accommodated in the external members 14 and 24.

The fuel cell 110 was installed in the system including the measuring section 120, the controlling section 130, the electrolyte supplying section 140, and the fuel supplying section 150 which have the above-described structures, and the fuel cell system 1 illustrated in FIG. 3 was thus constituted. At that time, the fuel/electrolyte supply adjusting section 142 and the fuel supply adjusting section 152 were constituted of diaphragm metering pumps (manufactured by KNF. Co., Ltd), and, from the respective pumps, the fuel/electrolyte supply line 143 of a silicone tube was directly connected to the electrolyte/fuel inlet 14A, the fuel supply line 153 was directly connected to the fuel/electrolyte storing section 141, and the arbitrary amount of methanol was supplied so that the methanol concentration in the fuel/electrolyte storing section 141 was 1M at any time. A mixed solution of the methanol with a concentration of 1M and the sulfuric acid with a concentration of 1M was used as the electrolyte of the fluid, and was supplied to the fuel cell 110 at a flow rate of 1.0 ml/min.

Evaluation

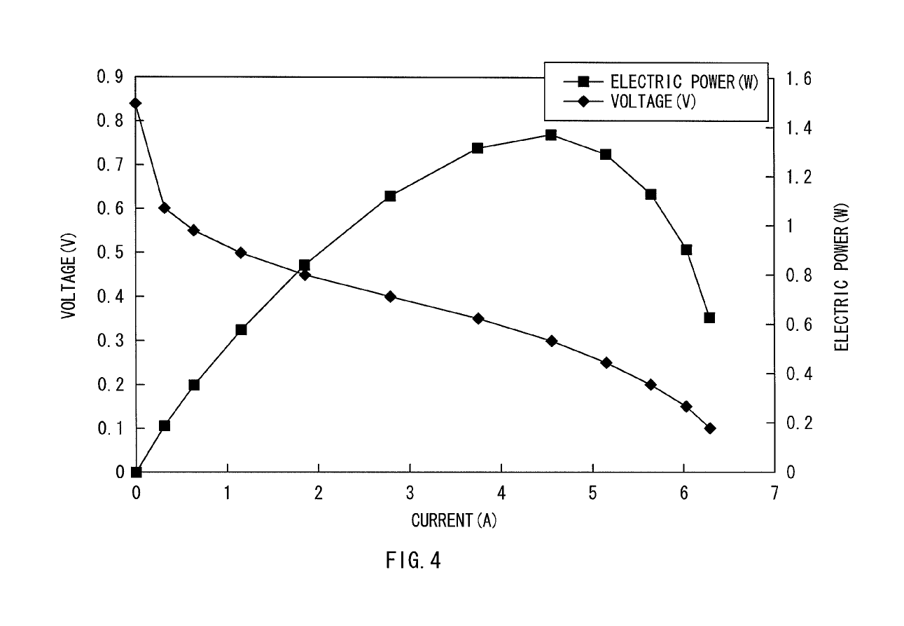

FIG. 4 illustrates the voltage characteristics and the electric power characteristics to the current of the fuel cell 110 provided with the water repellent region 60.

A pressure gauge was provided in the air outlet 24B to measure the pressure, and it could be seen that by providing the water repellent region 60, the pressure loss at the measurement time was reduced 10% to 20% and improved compared with a fuel cell of the related art not including the water repellent region. It is considered that this is because the water discharge is more efficiently performed than the fuel cell of related art.

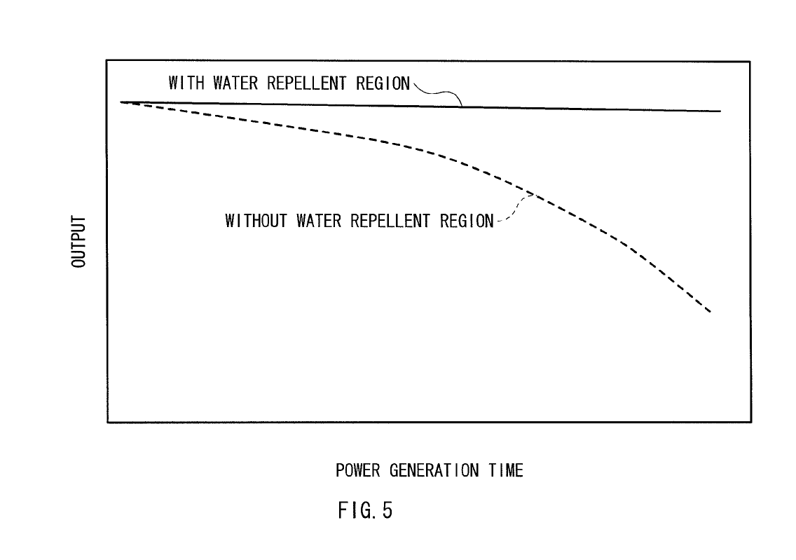

FIG. 5 illustrates long-term characteristics of the fuel cell 110 depending on presence or absence of the water repellent region 60. It can be seen that the power generation time and the power generating characteristics are extremely stabled because there is the water repellent region 60 on the current collector 23.

Hereinbefore, although the present disclosure has been described with the example embodiment and the example, the present disclosure is not limited to the above-described example embodiment ant the like, and various modifications can be made. For example, although the functional layer 51 is provided in the above-described example embodiment and the like, it is possible to provide no functional layer.

Moreover, although the structures of the fuel electrode 10, the oxygen electrode 20, the fuel/electrolyte flow path 30, and the air flow path 40 have been specifically described in the above-described example embodiment and the like, they may be constituted of other structures or other materials. For example, as an alternative to the fuel/electrolyte flow path 30 in which the resin sheet is processed to form the flow path as described in the above-described example embodiment, the fuel/electrolyte flow path 30 may be constituted of a porous sheet or the like. Moreover, an electrolytic membrane may be arranged in substitution for the fuel/electrode flow path 30.

Further, the fluid containing the fuel and the electrolytic solution is not limited to the fluid having the proton (H+) conductivity such as a phosphoric acid and an ionic liquid in addition to the sulfuric acid, but may be, for example, an alkali electrolytic solution. Furthermore, the fuel described in the above-described example embodiment may be other alcohols such as ethanol and dimethyl ether, or a sugar fuel, in addition to the methanol.

Moreover, although the case in which the air is supplied to the oxygen electrode 20 has been described in the above-described example embodiment and the like, oxygen or a gas containing oxygen may be supplied in substitution of the air. Further, although the present disclosure has been described with the example of the structure in which the fuel cell system 1 used in the electronic device includes the one fuel cell 110, the plurality of fuel cells 110 may be included. Thereby, the output becomes higher, and the fuel cell system 1 can be suitably used in an electronic device with high power consumption. Moreover, the material, and the thickness of each component, the operation conditions of the fuel cell 110, and the like are not limited, but other materials, other thickness, and other operation conditions may be adopted.

Moreover, although the present disclosure has been described with the example of the direct methanol fuel cell as the fuel cell in the above-described example embodiment and the like, it is not limited to this. The present disclosure is applicable to a fuel cell using, as the fuel, a substance other than a liquid fuel such as hydrogen, for example, a PEFC (Polymer Electrolyte Fuel Cell), an alkali fuel cell, an oxygen cell utilizing a sugar fuel such as glucose, or the like.

It should be understood that various changes and modifications to the presently preferred example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1-6. (canceled)

7. A fuel cell comprising:
an oxide electrode including:
(a) a first face and a second face facing each other; and
(b) a current collector on the first face;
an air-flow-path formation member forming an air flow path in corporation with the current collector;
a water repellent region formed on the current collector corresponding to at least part of the air flow path; and
a fuel electrode disposed on the second face of the oxygen electrode.

8. The fuel cell of claim 7, wherein the air-flow-path formation member is:
(a) an adhesive film including a groove for the air flow path; and
(b) bonded onto the current collector.

9. The fuel cell of claim 1, wherein the water repellent region is formed on a whole region along the air flow path.

10. The fuel cell of claim 1, wherein the current collector of the oxygen electrode is a porous material formed of a metal material.

11. An oxygen electrode comprising:
a current collector on a catalyst layer with a diffusing layer in between, wherein:
(a) an air-flow-path formation member forming an air flow path in corporation with the current collector is provided on the current collector side;
(b) a water repellent region is included in a position corresponding to at least part of the air flow path on a surface of the current collector; and
(c) the oxygen electrode constitutes a fuel cell in corporation with a fuel electrode disposed on the catalyst layer side.

12. An electronic device comprising:
a fuel cell which includes:
(a) an oxide electrode including a first face and a second face facing each other, and including a current collector on the first face;
(b) an air-flow-path formation member forming an air flow path in corporation with the current collector;
(c) a water repellent region formed on a surface of the current collector corresponding to at least part of the air flow path; and
(d) a fuel electrode disposed on the second face side of the oxygen electrode.
